(19) United States
(12) Patent Application Publication
(10) Pub. No.: US 2021/0355605 A1
(43) Pub. Date: Nov. 18, 2021

(54) ELECTROSTATIC SPINNING DEVICE

(71) Applicant: KAO CORPORATION, Tokyo (JP)

(72) Inventors: Shinji KODAMA, Sumida-ku (JP); Susumu FUJINAMI, Sumida-ku (JP); Haruomi ENOMOTO, Sumida-ku (JP); Takahiro HIRANO, Haga-gun (JP); Takehiko TOJO, Haga-gun (JP)

(73) Assignee: KAO CORPORATION, Tokyo (JP)

(21) Appl. No.: 17/286,264

(22) PCT Filed: Oct. 16, 2019
(86) PCT No.: PCT/JP2019/040611

§ 371 Date: Apr. 16, 2021

(30) Foreign Application Priority Data
Oct. 17, 2018 (JP) 2018-196229
Oct. 11, 2019 (JP) 2019-188090

(51) Int. Cl. D01D 5/00

(52) U.S. Cl. CPC D01D 5/0061

(57) ABSTRACT

An electrostatic spinning device including a nozzle that sprays spinning liquid that has been charged; a switch that controls spray operation of the spinning liquid; and a housing that includes a bulging portion and a grip portion for grip of the user, the bulging portion bulging outward from a virtual line connecting a tip of the nozzle and an end of the switch on a side of the nozzle, an angle formed by an axis of the nozzle and an axis of the grip portion being 45 degrees or more.

### FIELD OF THE INVENTION

The present invention relates to an electrostatic spinning device.

### BACKGROUND OF THE INVENTION

Electrostatic spray devices for injecting liquid by electrostatic force have been conventionally known. For example, JP 2007-521941 A discloses an electrostatic spray device. The electrostatic spray device includes a motor, a high-voltage generator, and a battery within a housing sized to be grasped with a hand of a user. The electrostatic spray device applies liquid composition electrostatically charged by high voltage from the high-voltage generator from a nozzle toward skin of the user. A power source switch is provided on the device. The power source switch feeds power to the motor and the high-voltage generator when being pushed.

### SUMMARY OF THE INVENTION

The invention relates to an electrostatic spinning device of a handheld type having a shape or a size that allows a user to hold the electrostatic spinning device with a hand, comprising: a nozzle that sprays spinning liquid that has been charged; a switch that controls spray operation of the spinning liquid; and a housing that includes a bulging portion and a grip portion for grip of the user, the bulging portion bulging outward from a virtual line connecting a tip of the nozzle and an end of the switch on a side of the nozzle, an angle formed by an axis of the nozzle and an axis of the grip portion being 45 degrees or more.

### BRIEF DESCRIPTION OF THE DRAWINGS

FIG. 1 is a perspective view of an electrostatic spinning device according to a first embodiment of the invention.

FIG. 2 is a perspective view of a cartridge in the electrostatic spinning device according to the embodiment.

FIG. 3 is a plan view of the electrostatic spinning device according to the embodiment.

FIG. 4 is a side view of the electrostatic spinning device according to the embodiment.

FIG. 5 is a plan view of the gripped electrostatic spinning device according to the embodiment.

FIG. 6 is a plan view of an electrostatic spinning device according to a second embodiment of the invention.

FIG. 7 is a plan view of an electrostatic spinning device according to a third embodiment of the invention.

FIG. 8 is a plan view of an electrostatic spinning device according to a fourth embodiment of the invention.

FIG. 9 is a plan view of an electrostatic spinning device according to a comparative embodiment.

### DETAILED DESCRIPTION OF THE INVENTION

There has been conventionally known an electrostatic spinning device for spraying solution containing raw material for electrostatic spinning, that is, spinning liquid toward an object. When the spinning liquid is sprayed, a solvent evaporates, and raw material becomes filamentous and deposits on the surface of the object.

An electrostatic spinning device of a handheld type having a shape and a size that allows a user to hold the electrostatic spinning device with a hand is required to be easily gripped and handled by the user. For example, when the user sprays spinning liquid toward his/her face, the user can preferably perform spray without unnatural movement such as lifting an arm or an elbow upward from the viewpoint of reducing a burden on, for example, the arm. When the user performs spray toward his/her limb, a hand gripping the device is preferably prevented from hiding a tip of a nozzle or an object to be sprayed from the viewpoints of accurate spray and improvement of operability. A hand gripping the electrostatic spinning device has a low potential. When no obstacle is placed between the tip of the nozzle and the hand, spinning liquid sprayed from the tip of the nozzle or contents thereof after evaporation of a solvent may change directions, turn around, and head toward the hand. Unfortunately, a traditional electrostatic spinning device has had difficulty in achieving improvement for easy handling and prevention of turning around of, for example, the spinning liquid as described above.

The invention relates to a handheld-type electrostatic spinning device capable of achieving both of improvement for easy handling and prevention of turning around of, for example, sprayed spinning liquid.

In order to solve the above-described problem, according to a viewpoint of the invention, there is provided an electrostatic spinning device of handheld type, including: a nozzle that sprays spinning liquid that has been charged; a switch that controls spray operation of the spinning liquid; and a housing that includes a bulging portion and a grip portion for grip of the user, the bulging portion bulging outward from a virtual line connecting a tip of the nozzle and an end of the switch on a side of the nozzle, an angle formed by an axis of the nozzle and an axis of the grip portion being 45 degrees or more.

According to the electrostatic spinning device of the invention, both of improvement for easy handling and prevention of turning around of, for example, sprayed spinning liquid can be achieved.

Preferred embodiments of the invention will be described in detail below with reference to the accompanying drawings. In the present specification and the drawings, the same signs are attached to elements having substantially the same function and configuration, and overlapping description thereof is omitted.

### First Embodiment

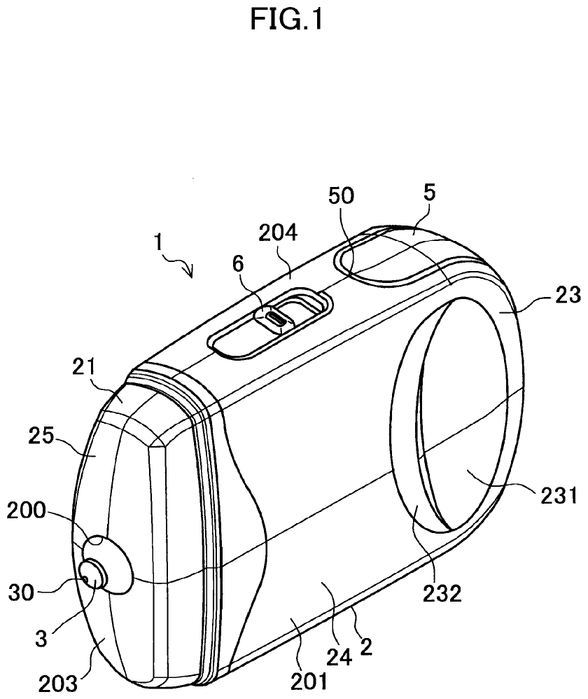

An electrostatic spray method is adopted in an electrostatic spinning device 1 according to a first embodiment in FIG. 1. In the electrostatic spray method, positive or negative high voltage is applied to liquid to charge the liquid, and the charged liquid is sprayed toward an object. The liquid may be a composition containing a plurality of components. The sprayed liquid is repeatedly divided into pieces by Coulomb repulsion to spread into space. In the process or after the liquid attaches to the object, a solvent, which is a volatile, dries, and thereby a film can be formed on the surface of the object. Hereinafter, a liquid containing raw material for electrostatic spinning and to which a high voltage is applied is referred to as spinning liquid. The electrostatic spinning device 1 is a type of electrostatic spray device that can be used for, for example, an operation with a hand of a person and personal use of a user. Fibrous deposits can be made on the surface of the object by spraying spinning liquid toward the object. Examples of the object include a part of a human body, for example, skin or a nail of the user himself/herself or another person.

When the fibrous deposits are formed by the electrostatic spray method, the fibers preferably have a cross-sectional shape of a circle or an ellipse. The thickness of a fiber may correspond to the diameter when the fiber has a cross-sectional shape of a circle, or the length of the major axis when the fiber has a cross-sectional shape of an ellipse. When expressed in the diameter of a circle, the fiber has a thickness of preferably 10 nm or more, and even more preferably 50 nm or more. The fiber has a thickness of preferably 3000 nm or less, and even more preferably 1000 nm or less. The thicknesses of fibers can be measured by, for example, the following method. That is, fibers are enlarged 10,000 times with a scanning electron microscope (SEM) and observed. Defects (fiber masses, fiber intersections, and droplets) are removed from a two-dimensional image of the fibers. Randomly, 10 fibers are selected from the fibers. A line orthogonal to the longitudinal direction of the fibers is drawn, and the diameters of the fibers are directly read. The thicknesses of the fibers can thereby be measured.

Although a fiber forming a film has an infinite length in principle of production, the fiber preferably has a length at least 100 times or more longer than the thickness of the fiber in practice. For example, a formed film contains fibers having a length of preferably 10 μm or more, more preferably 50 μm or more, and even more preferably 100 μm or more.

The spinning liquid will be described in detail below. For example, a solution in which macromolecular compounds capable of forming fibers are dissolved in a solvent can be used as the spinning liquid. Both water-soluble macromolecular compounds and water-insoluble macromolecular compound can be used as such macromolecular compounds.

The “water-soluble macromolecular compound” in the present specification has a property capable of being dissolved in water to the extent that, when macromolecular compounds are immersed in water having a mass of 10 times or more of that of the macromolecular compounds and enough time (e.g., 24 hours or more) elapses in an environment of one atmosphere and ordinary temperature (20° C.±15° C.), 50 mass % or more of the immersed macromolecular compounds is dissolved. In contrast, the “water-insoluble macromolecular compound” has a property of being not easily dissolved in water to the extent that, when macromolecular compounds are immersed in water having a mass of 10 times or more of that of the macromolecular compounds and enough time (e.g., 24 hours or more) elapses in the environment of one atmosphere and ordinary temperature (20° C.±15° C.), 80 mass % or more of the immersed macromolecular compounds is not dissolved.

Examples of the water-soluble macromolecular compound include mucopolysaccharides, such as pullulan, hyaluronic acid, chondroitin sulfate, poly gamma-glutamic acid, denatured corn starch, β-glucan, glucooligosaccharide, heparin, keratosulfate, natural macromolecules, such as cellulose, pectin, xylan, lignin, glucomannan, galacturonic, psyllium seed gum, tamarind seed gum, gum arabic, gum tragacanth, denatured corn starch, soybean water-soluble polysaccharide, alginic acid, carrageenan, laminaran, agar (agarose), fucoidan, methyl cellulose, hydroxypropyl cellulose, hydroxypropyl methyl cellulose, and synthetic macromolecules, such as partially saponified polyvinyl alcohol (when not used in combination with a crosslinking agent), low-saponified polyvinyl alcohol, polyvinylpyrrolidone (PVP), polyethylene oxide, and sodium polyacrylate. These water-soluble macromolecular compounds can be used alone or in combination of two or more types. Pullulan and synthetic macromolecules such as partially saponified polyvinyl alcohol, low-saponified polyvinyl alcohol, polyvinylpyrrolidone, and polyethylene oxide among these water-soluble macromolecular compounds are preferably used from the viewpoint of easiness of fiber formation.

In contrast, examples of the water-insoluble macromolecular compound include fully saponified polyvinyl alcohol that can be insolubilized after fiber formation, partially saponified polyvinyl alcohol that can be crosslinked after fiber formation by using a crosslinking agent, oxazoline denatured silicone such as poly (N-propanoylethyleneimine) graft-dimethylsiloxane/γ-aminopropylmethyllsiloxane copolymer, zein (main component of corn protein), polyester, polylactic acid (PLA), acrylic resin such as polyacrylonitrile resin and polymethacrylic acid resin, polystyrene resin, polyvinyl butyral resin, polyethylene terephthalate resin, polybutylene terephthalate resin, polyurethane resin, polyamide resin, polyimide resin, and polyamideimide resin. These water-insoluble macromolecular compounds can be used alone or in combination of two or more types.

When a water-insoluble macromolecular compound is used, spinning liquid contains the following components (a), (b), and (c). The mass ratio (b/c) of the component (b) and the component (c) is preferably 0.4 or more and 50 or less.

(a) One or more types of volatiles selected from alcohols and ketones

(b) Water-insoluble polymer for fiber formation

(c) Water

The volatile of the component (a) has volatility in the state of liquid. The spinning liquid contains the component (a) in order to form a film containing dry fibers. After the spinning liquid placed in an electric field is sufficiently charged, the spinning liquid is ejected from a nozzle tip to an object such as skin. As the component (a) evaporates, the charge density of the spinning liquid becomes excessive. While the spinning liquid is further divided into pieces by Coulomb repulsion, the component (a) further evaporates. Finally, the film is formed. For this purpose, at 20° C., the volatile has a vapor pressure of preferably 0.01 kPa or more and 106.66 kPa or less, more preferably 0.13 kPa or more and 66.66 kPa or less, even more preferably 0.67 kPa or more and 40.00 kPa or less, and further preferably 1.33 kPa or more and 40.00 kPa or less.

For example, a monovalent chain aliphatic alcohol, a monovalent cyclic aliphatic alcohol, and a monovalent aromatic alcohol among the volatiles of the component (a) are preferably used as an alcohol. Examples of the monovalent chain aliphatic alcohol include C1-C6 alcohol. Examples of the monovalent cyclic alcohol include C4-C6 cyclic alcohol. Examples of the monovalent aromatic alcohol include benzyl alcohol and phenylethyl alcohol. Specific examples thereof include ethanol, isopropyl alcohol, butyl alcohol, phenylethyl alcohol, n-propanol, and n-pentanol. One type or two or more types of alcohols selected therefrom can be used.

Examples of ketones include di C1-C4 alkylketone such as acetone, methyl ethyl ketone, and methyl isobutyl ketone among the volatiles of the component (a). One type of these ketones can be used alone, or two or more types can be used in combination.

The volatile of the component (a) is one type or two or more types selected from more preferably ethanol, isopropyl alcohol, and butyl alcohol, even more preferably one type or two types selected from ethanol and butyl alcohol, and even more preferably ethanol.

The spinning liquid has a content of the component (a) of preferably 50 mass % or more, more preferably 55 mass % or more, even more preferably 60 mass % or more, and further preferably 65 mass % or more. The spinning liquid has a content of the component (a) of preferably 95 mass % or less, more preferably 92 mass % or less, even more preferably 90 mass % or less, and further preferably 88 mass % or less. The spinning liquid has a content of the component (a) of preferably 50 mass % or more and 95 mass % or less, more preferably 55 mass % or more and 92 mass % or less, even more preferably 60 mass % or more and 90 mass % or less, and further preferably 65 mass % or more and 88 mass % or less. The proportion of the component (a) contained in the spinning liquid allows the spinning liquid to sufficiently volatilize in the electrostatic spray method, whereby a film containing fibers can be formed on the surface of an object such as skin.

Water-insoluble polymer for fiber formation of the component (b) is a substance that can be dissolved in the volatile of the component (a). Here, “dissolved” means a visually uniform dispersed state at 20° C., and preferably a visually transparent or translucent state.

An appropriate substance is used as the water-insoluble polymer for fiber formation in accordance with the characteristics of the volatile of the component (a). Specifically, a polymer that is soluble in the component (a) and insoluble in water is used. The “water-soluble polymer” in the present specification has a property in which, when 1 g of polymer is weighed to be immersed in 10 g of ion exchange water and then 24 hours elapses in an environment of one atmosphere and 23° C., 0.5 g or more of the immersed polymer is dissolved in water. In contrast, the “water-insoluble polymer” in the present specification has a property in which, when 1 g of polymer is weighed to be immersed in 10 g of ion exchange water and then 24 hours elapses in an environment of one atmosphere and 23° C., 0.5 g or more of the immersed polymer is not dissolved, in other words, a property of less than 0.5 g of dissolution amount.

Examples of the water-insoluble polymer having a fiber formation ability include fully saponified polyvinyl alcohol that can be insolubilized after fiber formation, partially saponified polyvinyl alcohol that can be crosslinked after fiber formation by using a crosslinking agent, oxazoline denatured silicone such as poly (N-propanoylethyleneimine) graft-dimethylsiloxane/γ-aminopropylmethyllsiloxane copolymer, polyvinyl acetal diethyl aminoacetate, zein (main component of corn protein), polyester, polylactic acid (PLA), acrylic resin such as polyacrylonitrile resin and polymethacrylic acid resin, polystyrene resin, polyvinyl butyral resin, polyethylene terephthalate resin, polybutylene terephthalate resin, polyurethane resin, polyamide resin, polyimide resin, and polyamideimide resin. One type or two or more types selected from these water-insoluble polymers can be used in combination. One type or two or more types selected from fully saponified polyvinyl alcohol that can be insolubilized after fiber formation, partially saponified polyvinyl alcohol that can be crosslinked after film formation by using a crosslinking agent, polyvinyl butyral resin, acrylic resin such as polymethacrylic acid resin, polyvinyl acetal diethyl aminoacetate, oxazoline denatured silicone such as poly (N-propanoylethyleneimine) graft-dimethylsiloxane/γ-aminopropylmethyllsiloxane copolymer, polylactic acid (PLA), zein among these water-insoluble polymers are preferably used.

The spinning liquid has a content of the component (b) of preferably 4 mass % or more, more preferably 6 mass % or more, and even more preferably 8 mass % or more. The spinning liquid has a content of the component (b) of preferably 35 mass % or less, more preferably 30 mass % or less, and even more preferably 25 mass % or less. The spinning liquid has a content of the component (b) of preferably 4 mass % or more and 35 mass % or less, more preferably 6 mass % or more and 30 mass % or less, and even more preferably 8 mass % or more and 25 mass % or less. The proportion of the component (b) contained in the spinning liquid allows stable and efficient formation of a fibrous film.

Since water of the component (c) is ionized and charged as compared with a solvent that does not ionize, such as ethanol, conductivity can be imparted to the spinning liquid. This allows stable formation of a fibrous film on the surface of an object such as skin by electrostatic spray. Water contributes to the improvement of adhesion of the film, which is formed by electrostatic spray, to an object such as skin and improvement of durability of the film. From the viewpoint of obtaining these effects, the spinning liquid preferably contains the component (c) of 0.2 mass % or more and 25 mass % or less. The spinning liquid has a content of the component (c) of preferably 0.3 mass % or more, more preferably 0.35 mass % or more, and even more preferably 0.4 mass % or more. The spinning liquid has a content of the component (c) of preferably 20 mass % or less, more preferably 19 mass % or less, and even more preferably 18 mass % or less. The spinning liquid has a content of the component (c) of 0.2 mass % or more and 25 mass % or less, preferably 0.3 mass % or more and 20 mass % or less, more preferably 0.35 mass % or more and 19 mass % or less, and even more preferably 0.4 mass % or more and 18 mass % or less.

From the viewpoints of forming a fibrous film on the surface of an object such as skin, improving the adhesion of the film to the object, and improving the durability of the film, the mass ratio (b/c) of the component (b) and the component (c) is preferably 0.4 or more and 50 or less. The mass ratio (b/c) is preferably 0.5 or more, and more preferably 0.6 or more. The mass ratio (b/c) is preferably 45 or less, and more preferably 40 or more. The range of the mass ratio (b/c) is preferably 0.4 or more and 50 or less, more preferably 0.5 or more and 45 or less, even more preferably 0.55 or more and 40 or less, and further preferably 0.6 or more and 40 or less.

From the viewpoints of stably obtaining a fibrous film by direct electrostatic spray of spinning liquid, improving the adhesion of the obtained film, and improving the durability of the film, the mass ratio (a/c) of the component (a) and the component (c) is preferably 3 or more and 300 or less. The mass ratio (a/c) is more preferably 3.5 or more, and even more preferably 4 or more. The mass ratio (a/c) is more preferably 250 or less, and even more preferably 210 or less. The range of the mass ratio (a/c) is more preferably 3.5 or more and 250 or less, and even more preferably 4 or more and 210 or less.

From the viewpoints of dispersibility of the component (b) in the spinning liquid, formability of a film, and durability of the film, the mass ratio (b/a) of the component (b) and the component (a) is preferably 0.01 or more, more preferably 0.02 or more, even more preferably 0.04 or more, and still more preferably 0.07 or more. The mass ratio (b/a) is preferably 0.55 or less, more preferably 0.50 or less, even more preferably 0.30 or less, and still more preferably 0.25 or less.

The spinning liquid may contain only the above-described components (a) to (c), or may contain another component in addition to the components (a) to (c). Examples of the other component include polyol, liquid oil, plasticizers for the polymer of the component (b), conductivity control agents in spinning liquid, water-soluble polymers other than the component (b), powders such as coloring pigments and extender pigments, dyes, perfumes, repellents, antioxidants, stabilizers, preservatives, and various vitamins. When the spinning liquid contains another component, the proportion of the other contained component is preferably 0.1 mass % or more and 30 mass % or less, and even more preferably 0.5 mass % or more and 20 mass % or less.

The spinning liquid may contain powders such as coloring pigments and extender pigments. The content of powders having a particle size of 0.1 μm or more at 20° C. is preferably 1 mass % or less, more preferably 0.1 mass % or less, and even more preferably 0.01 mass % or less from the viewpoints of formability of a uniform film and durability and adhesion of the film. The spinning liquid preferably does not contain powder except as such powder is unavoidably mixed.

The spinning liquid preferably has a viscosity of 2 to 3000 mPa·s at 25° C. from the viewpoints of stably forming a fibrous film, spinnability at the time of electrostatic spray, improving durability of the film, and improving the feel of the film. The viscosity is preferably 10 mPa·s or more, more preferably 20 mPa·s or more, and even more preferably 30 mPa·s. The viscosity is preferably 1500 mPa·s or less, more preferably 1000 mPa·s or less, and even more preferably 800 mPa·s or less. The range of the viscosity is preferably 2 mPa·s or more and 3000 mPa·s or less, more preferably 20 mPa·s or more and 1500 mPa·s or less, even more preferably 30 mPa·s or more and 1000 mPa·s or less, and even more preferably 30 mPa·s or more and 800 mPa·s or less. The viscosity of the spinning liquid is measured by using an E-type viscometer at 25° C. For example, an E-type viscometer (VISCONIC EMD) manufactured by TOKYO KEIKI INC. can be used as the E-type viscometer. In that case, 25° C., cone plate rotor NO. 43, and an appropriate revolution in accordance with a viscosity are selected as measurement conditions. The revolution at the viscosity of 1300 mPa·S or more is 5 rpm. The revolution at the viscosity of 250 mPa·S or more and less than 1300 mPa·S is 10 rpm. The revolution at the viscosity of 25 mPa·S or more and less than 250 mPa·S is 50 rpm. The revolution at the viscosity of less than 25 mPa·S is 100 rpm.

The configuration of the electrostatic spinning device 1 according to the first embodiment of the invention will now be outlined with reference to FIGS. 1 to 4. The electrostatic spinning device 1 is of handheld type, and has a shape, size, and weight that allow a user to hold and use the electrostatic spinning device 1 in one hand, for example. As illustrated in FIG. 1, the electrostatic spinning device 1 (hereinafter, simply referred to as the device 1) includes a housing 2, a nozzle 3, a switch 5, and a switch 6. The housing 2 is an outer shell member that covers the outside of the device 1, and houses, for example, a container, a battery, a high-voltage generator, electrodes, a motor, a pump, and a controller. Resin of insulating material can be used as material constituting the housing 2. The material constituting the housing 2 preferably contains an antistatic agent, and the outer surface of the housing 2 is preferably coated. In contrast, a region formed of conductive material is preferably provided at a position touched by a hand of the user on the outer surface of the housing 2 at the time when the user grips the device 1. The switches 5 and 6 to be touched by a finger of the user at the time of using the device 1 is more preferably formed of the conductive material. Examples of the conductive material include a mixed material of metal and resin in addition to metal.

The container houses spinning liquid. The battery functions as a power source capable of feeding power to the high-voltage generator and the motor. The high-voltage generator generates high voltage, and supplies the high voltage to an electrode. The motor drives the pump. The controller can control the operations of the motor and the high-voltage generator. The pump is, for example, a gear pump. The pump sucks in the spinning liquid from the container, and supplies the spinning liquid into a passage inside the nozzle 3. A spray port is provided at a tip 30 of the nozzle 3. The passage inside the nozzle 3 connected to the spray port is linear, and an electrode is installed in the passage. When the spinning liquid is supplied to the nozzle 3 and a high voltage is applied to the spinning liquid via the electrode, the charged spinning liquid is sprayed from the spray port of the nozzle 3 toward an object due to the potential difference between the object and the electrode.

The voltage applied to the electrode of the device (spinning voltage: corresponding to the potential difference between the electrode and the object) is preferably 5 kV or more, more preferably 8 kV or more, and even more preferably 10 kV or more from the viewpoint of sufficiently charging the spinning liquid. The spinning voltage is preferably 30 kV or less, and more preferably 25 kV or less from the viewpoint of, for example, preventing the discharge between the electrode and the object. From the above-described viewpoints, the spinning voltage is preferably 5 kV or more and 30 kV or less, and more preferably 10 kV or more and 25 kV or less.

The switches 5 and 6 are user-operable operation switches for operating the device 1 and spaying the spinning liquid from the nozzle 3. The switches 5 and 6 are provided so as to switch electrical connection and disconnection between the high-voltage generator, the motor, or the controller and the battery in accordance with an operation of the user. The switch 6 switches on/off of the power source of the device 1. When the switch 6 is turned on, the device 1 can operate to spray the spinning liquid, that is, perform a spray operation. When the switch 6 is turned off, the spray operation is made impossible. The switch 6 may have another function. For example, the switch 6 may be provided so as to change a set amount of the spinning liquid to be sprayed. In contrast, the switch 5 is provided so as to control the spray operation in the state where the spray operation is possible, in other words, after the switch 6 is turned on and the spray operation is made possible. Although controlling spray operation means switching between the presence or absence of the spray operation, in other words, the start and stop of the spray, this is not a limitation. Controlling spray operation may mean changing and adjusting an amount of the spinning liquid to be sprayed. Specifically, the switch 5 is pushed in the direction toward the inside of the housing 2. The switch 5 is configured to spray the spinning liquid from the nozzle 3 while being pressed and to stop the spray when being released. In this way, the switch 5 functions as a control switch for controlling the spray operation for the spinning liquid. From the viewpoint of operability of the spray operation, one switch 5 is preferably provided.

During electrostatic spray, a high potential difference is preferably generated between, for example, skin, which is an object (hereinafter, referred to as a spinning target), and the nozzle 3. From such a viewpoint, a region gripped by a user, preferably the switch 5 is preferably formed of conductive material in the device 1. This causes the current from the inside of the device 1 to easily flow to the user, and increases the potential difference between the nozzle 3 and the spinning target, thereby improving spinnability. The present inventors have confirmed that impedance is so large that the current flowing through the user during electrostatic spray is quite small. The current is a few orders of magnitude smaller than, for example, current flowing through a human body by static electricity that generates in normal life.

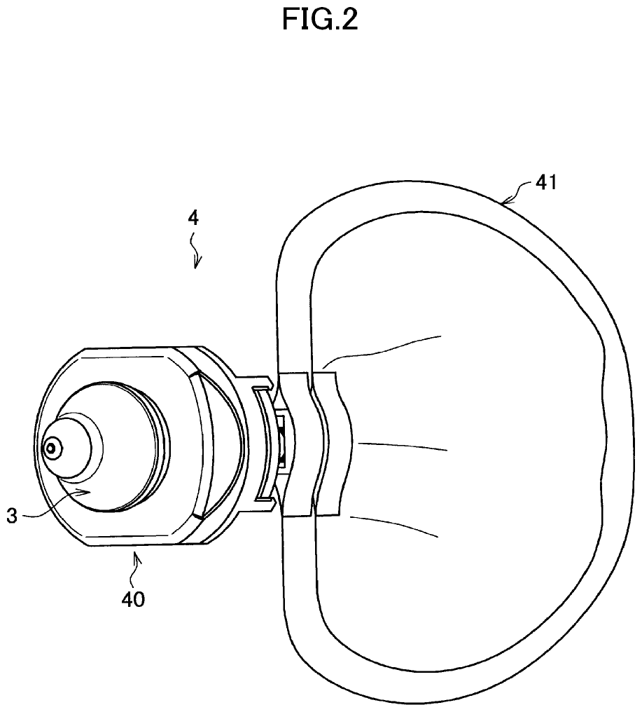

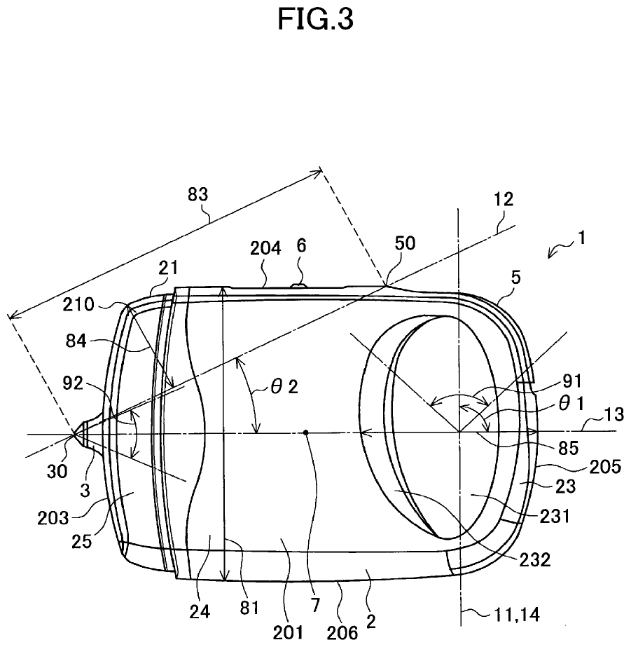

As illustrated in FIG. 3, an axis 13 of the nozzle 3 extends along the direction in which the spinning liquid is sprayed from the nozzle 3. The axis 13 of the embodiment extends along the passage inside the nozzle 3. The nozzle 3 may be integrated with a cartridge 4 as illustrated in FIG. 2. The cartridge 4 includes a mounting portion 40 and a container 41. The mounting portion 40 houses a pump and an electrode. The container 41 is mounted on the mounting portion 40 together with the nozzle 3. The container 41 has a flattened bag shape, and is made of a sheet such as a thin film formed of insulating material. The container 41 houses liquid (spinning liquid), and is deformable. The cartridge 4 is detachably mounted on a mounted portion of the housing 2. A cover 25 is installed on a body of the housing 2 so as to cover the mounted cartridge 4. As illustrated in FIG. 1, the nozzle 3 protrudes through a hole 200 provided in the cover 25.

The housing 2 includes a grip portion 23 and a main housing portion 24. The grip portion 23 mainly houses the battery and the switch 5. It is highly probable that the grip portion 23 is gripped when the user uses the device 1. The grip portion 23 is expected to be gripped. The grip portion 23 overlaps with the switch 5 in the direction along the axis 13 of the nozzle 3. The grip portion 23 is positioned at an end of the device 1 in the direction opposite to the nozzle 3. The main housing portion 24 mainly houses the container 41, the pump, the electrode, the high-voltage generator, the motor, and the controller. The above-described cartridge 4 is mounted in the main housing portion 24. The cover 25 functions as a part of the main housing portion 24. The main housing portion 24 is continuous with the nozzle 3 via the cover 25. A portion of the housing 2 between the nozzle 3 and the switch 5 corresponds to the main housing portion 24.

The housing 2 has a flattened shape. Here, the flattened shape means the following. An x-axis, a y-axis, and a z-axis orthogonal to each other are assumed. The fact that an object has a flattened shape with a small thickness in a z-axis direction means that the object has a dimension in the z-axis direction a predetermined amount or more smaller than those in an x-axis direction and a y-axis direction. Specifically, the dimension, that is, thickness of the object in the z-axis direction is equal to or less than a value obtained by multiplying the dimension of the object in an x-axis direction by a predetermined ratio, and is equal to or less than a value obtained by multiplying the dimension of the object in a y-axis direction by the ratio. The outer surface of a flattened object has a flat portion and an outer edge portion. The flat portion spreads along a plane perpendicular to the z-axis direction in which the thickness of the object decreases. An angle formed by the flat portion to the plane is within a predetermined range. The outer edge portion surrounds the outer periphery of the flat portion. For example, a direction along the axis 13 of the nozzle 3 is defined as the x-axis direction in the housing 2 of the electrostatic spinning device 1 according to the embodiment. A direction that is orthogonal to the axis 13 and vertically extends in the plane of FIG. 3 is defined as the y-axis direction. A direction that is orthogonal to the axis 13 and perpendicularly extends to the plane of FIG. 3 is defined as the z-axis direction. The housing 2 has a flattened shape having a thickness in the z-axis direction smaller than those in the x-axis direction and the y-axis direction. The flat portion on the outer surface of the housing 2 is substantially rectangular in side view of the housing 2 as viewed from the z-axis direction.

The outer surface of the housing 2 has a first surface 201, a second surface 202, a third surface 203, a fourth surface 204, a fifth surface 205, and a sixth surface 206. Each of the surfaces 201 to 206 is curved bulging outward. The first surface 201 and the second surface 202 are wider than the third to sixth surfaces 203 to 206, and correspond to the above-described flat portions. The third surface 203 is a part of the cover 25. The nozzle 3 protrudes from the third surface 203. The first surface 201 and the second surface 202 are located on opposite sides across the axis 13 of the nozzle 3. The third to sixth surfaces 203 to 206 are located between the first surface 201 and the second surface 202, correspond to the outer edge portions, and surround the outer edges of the first surface 201 and the second surface 202. The axis 13 of the nozzle 3 extends along the x-axis direction, which corresponds to the longitudinal direction of the first surface 201, the second surface 202, the fourth surface 204, and the sixth surface 206. The axis 13 of the nozzle 3 is located at the center between the first surface 201 and the second surface 202, and at the center between the fourth surface 204 and the sixth surface 206. The axis 13 of the nozzle 3 passes through the center of the third surface 203 and the center of the fifth surface 205.

The switch 6 is provided on the fourth surface 204 of the main housing portion 24. A projection rising from the first surface 201 may be provided on the side closer to the nozzle 3 than a center 7 on the first surface 201 in the main housing portion 24. When the device 1 is placed on a table or the like, the projection abuts on a table or the like, and the tip of the nozzle 3 faces upward, whereby, for example, liquid bleeding of the nozzle 3 is prevented. It is more effective if such a projection is also located on the second surface 202, that is, on both flat portions of the housing 2.

The recess 231 and the projection 232 are formed on the first surface 201 of the grip portion 23. The recess 231 has a flattened circular outer edge extending in a direction orthogonal to the axis 13 of the nozzle 3, is recessed with respect to the first surface 201, and has a bottom surface having a recessed curved shape. A projection 232 is positioned adjacent to a recess 231 on the side of the nozzle 3. The projection 232 protrudes from the first surface 201. The projection 232 has a ridge along an outer edge of the recess 231 on the side of the nozzle 3. The projection 232 has a crescent shape that extends in a direction orthogonal to the axis 13 of the nozzle 3. As in the first surface 201, the recess 231 and the projection 232 are formed on the second surface 202 of the grip portion 23.

The switch 5 is provided on the fourth surface 204 and the fifth surface 205 of the grip portion 23. The switch 5 is located on the side opposite to the nozzle 3 with respect to the center 7 of the device 1 in the direction along the axis 13 of the nozzle 3. The switch 5 is located at the corner where the fourth surface 204 and the fifth surface 205 are connected, and extends over a predetermined range along the outer edges of the first surface 201 and the second surface 202 so as to straddle both of the fourth surface 204 and the fifth surface 205. A portion of the switch 5 on the fourth surface 204 overlaps with the recess 231 and the projection 232 in the direction along the axis 13 of the nozzle 3, and is movable. For example, when being pushed by the user, the switch 5 electrically connects the high-voltage generator and the motor and the battery. As with the movable portion of the switch 5 on the fourth surface 204, a portion of the switch 5 on the fifth surface 205 may achieve electrical connection by being pushed by the user, or may simply have a function as a fulcrum at the time when the movable portion is operated. The portion of the switch 5 on the fifth surface 205 may be omitted.

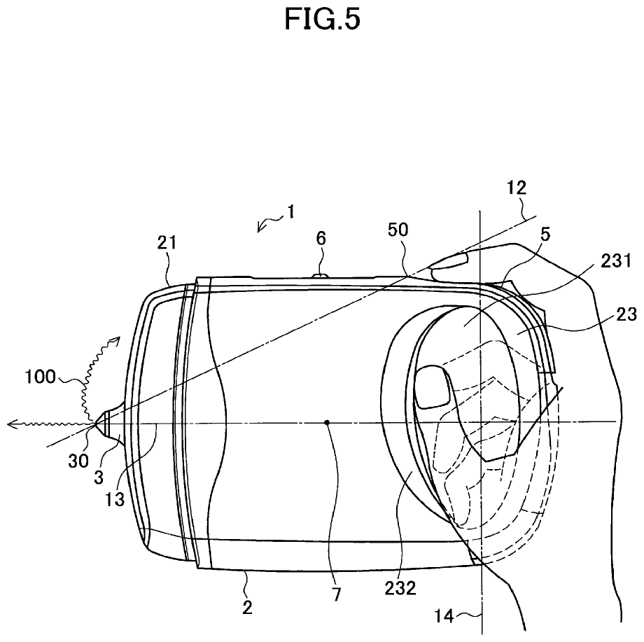

FIG. 5 illustrates one example of the grip portion 23 gripped with a hand of a user. The grip portion 23 may be sandwiched (grasped) by the palmar portion of the hand, and supported by fingers of the hand. The switch 5 is operated with a finger. Specifically, the grip portion 23 has a shape in which the grip portion 23 is supported by a thumb, a middle finger, a ring finger, and a little finger, and the switch 5 is easily operated by an index finger. The thumb is positioned in the recess 231 of the first surface 201. The middle finger, the ring finger, and the little finger are positioned in the recess 231 of the second surface 202. The index finger is positioned at the corner and the vicinity of the corner where the fourth surface 204 and the fifth surface 205 are connected, that is, the switch 5. The pad of the index finger is positioned at a portion of the switch 5 on the fourth surface 204. The portion of the switch 5 on the fourth surface 204 can be easily pushed down by moving a first joint or a second joint of the index finger. The switch 5 is disposed so that a pad of the index finger is positioned at a movable portion of the switch 5 when the thumb is positioned in the recess 231 on the first surface 201, and the middle finger, the ring finger, and the little finger are positioned in the recess 231 on the second surface 202. The projection 232 inhibits the fingers disposed in the recess 231 from sticking out of the recess 231 and moving toward the side of the nozzle 3. The grip portion 23 grasped by the palmar portion of a hand and the switch 5 operated with a finger of the hand described above allows the hand of a gripping person to be positioned on a side far from the nozzle 3.

The recess 231 and the projection 232 may be omitted. In the embodiment, the recess 231 and the projection 232 on the first surface 201 facilitate positioning of a thumb. The recess 231 and the projection 232 on the second surface 202 facilitate positioning of a middle finger, a ring finger, and a little finger.

A hand of a person who grips the grip portion 23 has a tubular shape. The axis of the tube can be assumed as an axis 14 of the grip portion 23. For example, in the example of a gripping method in FIG. 5, tubular space surrounded by the palmar portion sandwiching the grip portion 23 and fingers supporting the grip portion 23 can be regarded as having an axis that is orthogonal to the axis 13 of the nozzle 3 and that extends in a direction along the first surface 201 and the second surface 202. The axis can be defined as the axis 14 of the grip portion 23. The axis 14 can also be identified from the shape itself of the grip portion 23. For example, when the plan view shape of the recess 231 is viewed as an ellipse, the major-axis direction of the ellipse can be defined as a direction in which the axis 14 extends. Also, in this case, the axis 14 is orthogonal to the axis 13 of the nozzle 3, and extends in the direction along the first surface 201 and the second surface 202. The axis 13 of the nozzle 3 and the axis 14 of the grip portion 23 are not required to intersect with each other. In other words, both of the axes 13 and 14 are not required to be located on the same plane.

Here, an angle θ1 formed by the axis 13 of the nozzle 3 and the axis 14 of the grip portion 23 is sandwiched between both of the intersecting axes 13 and 14 as viewed from a direction orthogonal to both of the axes 13 and 14 as in FIG. 3. When the angle is not 90 degrees, a smaller (acute) angle among angles with two sizes sandwiched between both of the intersecting axes 13 and 14 is defined as θ1. In the embodiment, the angle θ1 is 90 degrees. That is, the angle θ1 is 45 degrees or more. This allows the user to easily grip and handle the device 1 when the user sprays the spinning liquid toward a body. For example, when the user performs spray toward his/her face, the user can perform spray without unnatural movement such as lifting an arm or an elbow upward, so that a burden on, for example, the arm is reduced. When the user performs spray toward his/her limb, a hand of the user who grips the device 1 is prevented from hiding the tip 30 of the nozzle 3 and an object to be sprayed from an end of a line-of-sight of the user. The user can visually recognize, for example, the tip 30 of the nozzle 3 during spray, whereby more accurate spray is possible, and operability of the device 1 is improved.

A hand gripping the device 1 has a low potential. When no obstacle is placed between the tip 30 of the nozzle 3 and the hand, the potential difference between an electrode and the hand may generate an electric field between charged spinning liquid in the nozzle 3 and the hand. In the case, spinning liquid sprayed from the spray port of the nozzle 3 or contents thereof after evaporation of a solvent may change directions, turn around, and head toward the hand. An arrow 100 in FIG. 5 indicates such a spray mode. Hereinafter, such a turning-around phenomenon is referred to as back spray. In the embodiment, the angle θ1 is 90 degrees, that is, 45 degrees or more. The proportion of the main housing portion 24 of the housing 2 as an obstacle against the back spray between the tip 30 of the nozzle 3 and the hand, in other words, the degree of hindering the occurrence of the electric field can thus be increased. The back spray can thus be inhibited. The present inventors have found that the angle θ1 is required to be 45 degrees or more in order to remarkably achieve each of the above-described advantages. That is, as illustrated in FIG. 3, the axis 14 of the grip portion 23 is required to be located within a range 91. As viewed from the direction orthogonal to the axis 13 of the nozzle 3 and the axis 14 of the grip portion 23, the range 91 has angles of 45 degrees with respect to a line 11 using the intersection of the axis 13 and the axis 14 as a vertex. The line 11 is a straight line that passes through the intersection of the axis 13 and the axis 14, and is orthogonal to the axis 13, as viewed from the direction orthogonal to the axis 13 and the axis 14. From the viewpoint as described above, the angle θ1 is 45 degrees or more, preferably 60 degrees or more, preferably 90 degrees or less, and preferably 60 degrees or more and 90 degrees or less.

The switch 5 is located on the side opposite to the nozzle 3 with respect to the center 7 of the device 1 in the direction along the axis 13 of the nozzle 3. The back spray can thus be more easily inhibited. That is, a finger of the user rests on the switch 5. The switch 5 disposed in the above-described way increases the distance between the tip 30 of the nozzle 3 and the finger resting on the switch 5. This inhibits back spray from the nozzle 3 to the finger. The center 7 of the device 1 may be located at an intermediate point between the tip 30 of the nozzle 3 and the fifth surface 205, for example, in plan view of FIG. 3.

The grip portion 23 overlaps with the switch 5 in the direction along the axis 13 of the nozzle 3. Even when each portion is disposed so that the user can operate the switch 5 with a finger of a hand while maintaining the position of the hand gripping the grip portion 23, the grip portion 23 disposed in the above-described way inhibits reduction of the distance between the tip 30 of the nozzle 3 and the hand, and the back spray can be inhibited.

A virtual straight line connecting the tip 30 of the nozzle 3 and an end 50 of the switch 5 on the side of the nozzle 3 is defined as a virtual line 12. The end 50 corresponds to, for example, an end of the movable portion of the switch 5. A portion bulging outward from the virtual line 12 of the main housing portion 24 is referred to as a bulging portion 21. Here, outward means the side away from the center 7 of the device 1. The bulging portion 21 bulges outward in a projected manner from the virtual line 12. The bulging portion 21 thus inhibits the spray mode (indicated by the arrow 100 in FIG. 5) in which spinning liquid or contents thereof sprayed from the spray port of the nozzle 3 heads toward a finger resting on the switch 5. That is, the bulging portion 21 hinders the occurrence of an electric field between the charged spinning liquid in the nozzle 3 and the finger on the switch 5, so that the occurrence itself of spray indicated by the arrow 100 is inhibited. In other words, the bulging portion 21 can prompt the main housing portion 24 to function as an obstacle against the back spray. The back spray can thus be more effectively inhibited.

Here, an angle θ2 formed by the axis 13 of the nozzle 3 and virtual line 12 is sandwiched between the axis 13 and the line 12 intersecting with each other as viewed from a direction orthogonal to the axis 13 and the line 12 as in the FIG. 3. When the angle is not 90 degrees, a smaller (acute) angle among angles with two sizes sandwiched between the axis 13 and the line 12 intersecting with each other is defined as θ2. The switch 5 disposed at a position deviated from the axis 13 of the nozzle 3 makes it easy for the user to operate the switch 5 with a finger of a hand while maintaining the position of the hand gripping the grip portion 23, whereby operability of the device 1 can be improved. The present inventors have found that the angle θ2 is preferably 25 degrees or more in order to remarkably achieve the above-described advantages. That is, as illustrated in FIG. 3, the virtual line 12 is preferably located outside a range 92. As viewed from the direction orthogonal to the axis 13 of the nozzle 3 and the virtual line 12, the range 92 has angles of 25 degrees with respect to the axis 13 using the tip 30 as a vertex. From the viewpoints of size inhibition or ease in handling of the device 1, the angle θ2 is preferably 90 degrees or less, and more preferably 45 degrees or less. From the viewpoint as described above, the angle θ2 is preferably 25 degrees or more and 90 degrees or less, and more preferably 25 degrees or more and 45 degrees or less. In the embodiment, the angle θ2 is 26 to 27 degrees.

As illustrated in FIG. 3, a corner 210 at the boundary between the third surface 203 and the fourth surface 204 among the outer surfaces of the main housing portion 24 has the largest distance from the virtual line 12, and corresponds to the vertex of the bulging portion 21. In short, the corner 210 where the third surface 203 and the fourth surface 204 intersect with each other corresponds to the vertex of the bulging portion 21. The nozzle 3 protrudes from the third surface 203. The switch 5 is provided on the fourth surface 204. The ratio of a distance 84 to a distance 83 is defined as R. The distance 83 is located between the tip 30 of the nozzle 3 and the end 50 of the switch 5 on the side of the nozzle 3. The distance 84 is located between the virtual line 12 and the vertex of the bulging portion 21. The distance 84 corresponds to the maximum length of the bulging portion 21 from the virtual line 12. If the distance which the spinning liquid or contents thereof must turn around to reach the finger from the tip 30 of the nozzle 3 is larger than a straight-line distance between the tip 30 of the nozzle 3 and a finger resting on the switch 5, back spray heading from the nozzle 3 toward the finger is effectively inhibited. The present inventors have found that the ratio R of the distance 84 to the distance 83 is preferably 0.20 or more, and more preferably 0.25 or more in order to remarkably achieve such an advantage. The present inventors have found that the distance 84 is preferably 2 cm or more in order to achieve the above-described advantage. From the viewpoints of size inhibition or ease in handling of the device 1, the ratio R of the distance 84 to the distance 83 is preferably 0.50 or less, and more preferably 0.40 or less. From the viewpoint as described above, the ratio R is preferably 0.20 or more and 0.50 or less, and more preferably 0.25 or more and 0.40 or less. In the embodiment, the ratio R is 0.28 to 0.29.

The distance 83 between the tip 30 of the nozzle 3 and the end 50 of the switch 5 on the side of the nozzle 3 is preferably 30 mm or more and 100 mm or less, and more preferably 40 mm or more and 80 mm or less from the viewpoints of, for example, ease in handling and inhibition of back spray. The total length of the device 1 is preferably 100 mm or more and 200 mm or less from the viewpoints of, for example, ease in handling and storage. The total length of the device 1 corresponds to, for example, the maximum length from the tip 30 of the nozzle 3 to a rear end of the grip portion 23 in the direction along the axis 13 of the nozzle 3.

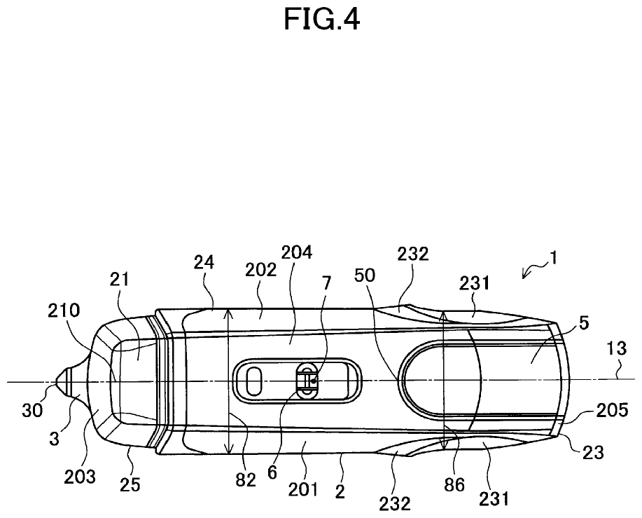

As illustrated in FIGS. 3 and 4, the grip portion 23 has a flattened shape. Two directions orthogonal to each other among directions orthogonal to the axis 14 of the grip portion 23, that is, radial directions of the grip portion 23 are defined as a first direction and a second direction. In the embodiment, the first direction is along the first surface 201 and the second surface 202, and the second direction is along the fifth surface 205. A dimension 85 of the grip portion 23 in the first direction in FIG. 3 is larger than a dimension 86 of the grip portion 23 in the second direction in FIG. 4.

Such a flattened shape of the grip portion 23 allows the user to easily grip the grip portion 23 with a hand. The flattened shape prevents the grip portion 23 from rotating in the hand, and facilitates positioning of the nozzle 3 with respect to an object. From such viewpoints, the dimension 86 may be larger than the dimension 85. In this case, the outer surface of a flattened portion of the grip portion 23 along a palm makes it easy to grip the grip portion 23. When the dimension 85 is larger than the dimension 86 as in the embodiment, sandwiching the grip portion 23 between a base of a thumb and a portion of a palm facing the base of the thumb as illustrated in FIG. 5 makes it easy to grip the grip portion 23.

As described above, the switch 5 is disposed on the flattened outer edge portion of the grip portion 23, that is, a portion of the fourth surface 204, and a portion of the fifth surface 205 adjacent to the fourth surface 204. In other words, the switch 5 is located on an end side of the outer surface of the grip portion 23 in the first direction, that is, the direction along the first surface 201 and the second surface 202. When the user grips the grip portion 23 with a hand, the switch 5 is easily disposed so that the pad of a finger of the hand is positioned at the movable portion of the switch 5. The switch 5 disposed in such a manner makes it easy for the user to operate the switch 5 with a finger of a hand while maintaining the position of the hand gripping the grip portion 23, whereby operability of the device 1 can be improved. For example, as illustrated in FIG. 5, when the grip portion 23 is sandwiched between the base of the thumb and the portion of the palm facing the base, the switch 5 is easily pushed with an index finger or a middle finger. From the viewpoints as described above, the ratio of the dimension 86 to the dimension 85 is preferably 50% or more, preferably 70% or more, preferably 120% or less, more preferably 100% or less, preferably 50% or more and 120%, and more preferably 70% or more and 100% or less. In the embodiment, the ratio of the dimension 86 to the dimension 85 is 80 to 90%.

As illustrated in FIGS. 3 and 4, the main housing portion 24 has a flattened shape, and is substantially rectangular in side view. The outer shape of the main housing portion 24 in a cross-sectional direction orthogonal to the axis 13 of the nozzle 3 is basically rectangular. Two directions orthogonal to each other among directions orthogonal to the axis 13 of the nozzle 3, that is, radial directions of the main housing portion 24 are defined as a third direction and a fourth direction. A dimension 81 of the main housing portion 24 in the third direction is larger than a dimension 82 of the main housing portion 24 in the fourth direction. In the embodiment, the third direction is along the first surface 201 and the second surface 202, and the fourth direction is along the fourth surface 204 and the sixth surface 206.

Such a flattened shape of the main housing portion 24 can, for example, improve layout property of the housing 2. That is, when a pump for supplying spinning liquid to the nozzle 3 is a suction-type pump such as a gear pump, the container 41 that contains the spinning liquid in FIG. 2 is preferably deformable, and has a flattened shape so that the pump efficiently sucks the liquid. When the container 41 is flattened in this way, the flattened main housing portion 24 that houses the container 41 can improve the layout property of the internal space of the housing 2 while making the housing 2 compact. From such viewpoints, the ratio of the dimension 82 to the dimension 81 is preferably 30% or more and 50% or less. In the embodiment, the ratio of the dimension 82 to the dimension 81 is 40 to 45%.

The main housing portion 24 of the housing 2 between the nozzle 3 and the switch 5 is flattened. The switch 5 is disposed at a position corresponding to the outer edge portion of the main housing portion 24, which is flattened as described above, that is, a portion of the fourth surface 204 and a portion of the fifth surface 205. The portion of the fourth surface 204 corresponds to the outer edge portion of the grip portion 23 continuous with the outer edge portion of the main housing portion 24. The fifth surface 205 is adjacent to the fourth surface 204. In other words, the switch 5 is located on an end side of the outer surface of the grip portion 23 adjacent to the outer surface of the main housing portion 24 in the third direction, that is, the direction along the first surface 201 and the second surface 202. The back spray can thus be more easily inhibited. That is, the switch 5 located at a position corresponding to the outer edge portion of the main housing portion 24 can guide a hand of the user, who grips the grip portion 23 while placing a finger on the switch 5, to a position farther from the nozzle 3. The switch 5 located at the position corresponding to the outer edge portion of the main housing portion 24 allows the extent that the main housing portion 24 bulges outward from the straight line 12 connecting the tip 30 of the nozzle 3 and the switch 5 as illustrated in FIG. 3, in other words, the ratio R of the distance 84 to the distance 83 to be more easily set large. The proportion of the main housing portion 24 as an obstacle between the tip 30 of the nozzle 3 and a finger resting on the switch 5 can be more easily increased.

The switch 5 is only required to be a control switch for controlling spray operation of spinning liquid. For example, the switch 5 sprays the spinning liquid from the nozzle 3 by being pushed. A finger of the user rests on the switch 5 while the device 1 is used. The above-described advantages such as inhibition of back spray from the nozzle 3 toward the finger are thus effectively achieved.

### Second Embodiment

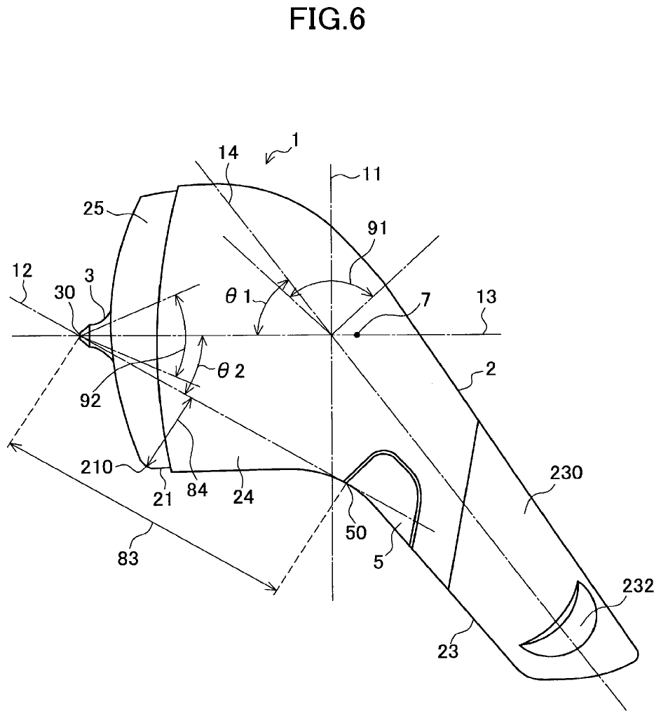

An electrostatic spinning device 1 according to a second embodiment will now be described with reference to FIG. 6. Configurations common to those in the first embodiment are given the same signs as those in the first embodiment, and the description thereof will be omitted.

A grip portion 23 includes a portion 230 having a shape bent with respect to an axis 13 of a nozzle 3. The portion 230 is, for example, cylindrical, and extends away from the nozzle 3 along an axis 14 that forms an angle θ1 greater than zero with respect to the axis 13 of the nozzle 3. The angle θ1 is 55 degrees. A user can easily grip the device 1 such that a tip 30 of the nozzle 3 faces his/her side by grasping the portion 230 while placing the pad of a thumb on a switch 5.

The grip portion 23 extending away from the nozzle 3 allows the distance between a hand of the user who grips the grip portion 23 and the tip 30 of the nozzle 3 to be secured so as to be large to some extent. The back spray can thus be inhibited.

The grip portion 23 overlaps with the switch 5, or is located on the side opposite to the nozzle 3 with respect to the switch 5 in a direction along the axis 13 of the nozzle 3. Even when the arrangement, in which the user can operate the switch 5 with a finger of a hand while maintaining the position of the hand gripping the grip portion 23, is adopted, the distance between the tip 30 of the nozzle 3 and the hand is inhibited from being reduced, and the back spray can be inhibited. In the embodiment, an angle 82 is 30 degrees, and the ratio R of a distance 84 to a distance 83 is 0.27 to 0.28.

### Third Embodiment

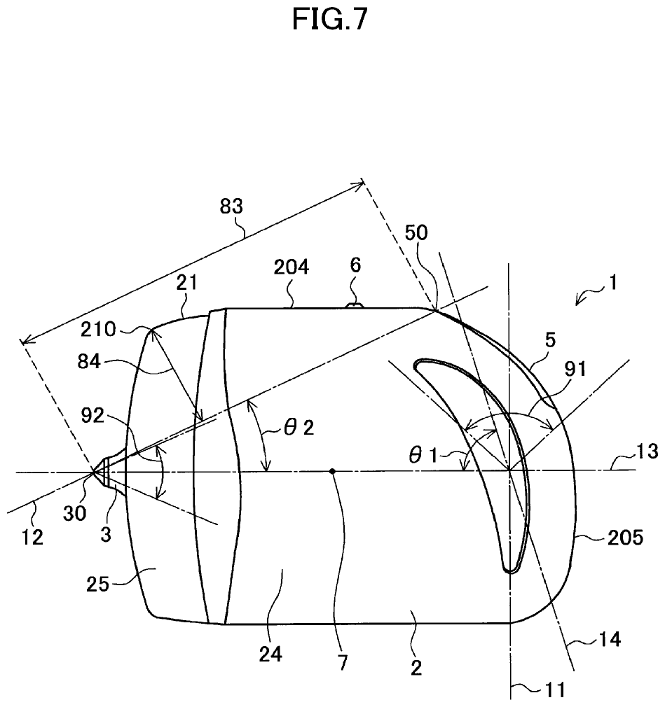

An electrostatic spinning device 1 according to a third embodiment will now be described with reference to FIG. 7. Configurations common to those in the first embodiment are given the same signs as those in the first embodiment, and the description thereof will be omitted.

The portion where the fourth surface 204 and the fifth surface 205 are connected is a curved surface having a curvature smaller than that of the corner in the first embodiment. A switch 5 is provided on the curved surface. A method of gripping the device 1 is similar to that in the first embodiment (FIG. 5). Since the connection portion between the fourth surface 204 and the fifth surface 205 is a gentle curved surface as described above, a joint of a finger placed on the switch 5, for example, an index finger is not required to be bent. This allows a user to easily grip and handle the device 1. An axis 14 of a grip portion 23 can be tilted with respect to a straight line 11 orthogonal to an axis 13. In the example in FIG. 7, an angle 81 formed by the axis 13 of the nozzle 3 and the axis 14 of the grip portion 23 is 73 degrees. In the embodiment, an angle 82 is 27 degrees, and the ratio R of a distance 84 to a distance 83 is 0.27 to 0.28.

### Fourth Embodiment

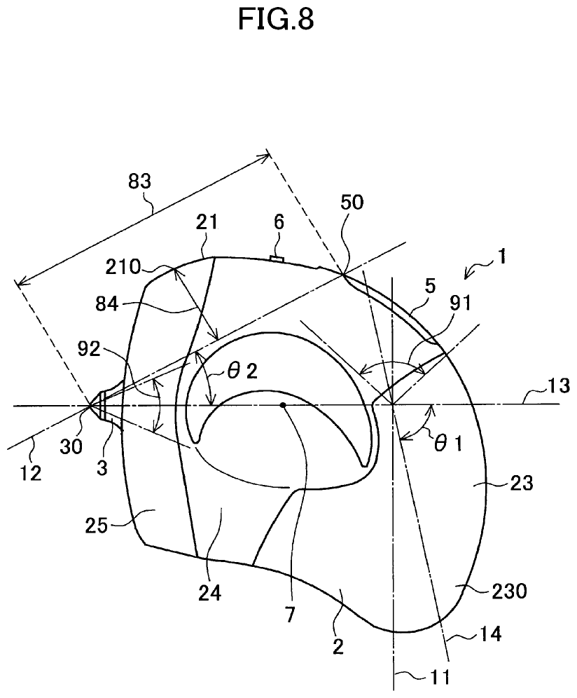

An electrostatic spinning device 1 according to a fourth embodiment will now be described with reference to FIG. 8. Configurations common to those in the first embodiment are given the same signs as those in the first embodiment, and the description thereof will be omitted.

A grip portion 23 includes a portion 230 having a shape gently bent with respect to an axis 13 of a nozzle 3. The portion 230 has a tapered shape extending to the side opposite to the switch 5 across the axis 13 of the nozzle 3. The portion 230 extends away from the nozzle 3 along an axis 14 that forms an angle θ1 greater than zero with respect to the axis 13 of the nozzle 3. A method of gripping the device 1 is similar to that in the first embodiment (FIG. 5). Since the portion where the switch 5 is provided has a curved surface similar to that in the third embodiment, the user can easily grip and handle the device 1.

As in the second embodiment, the grip portion 23 extends away from the nozzle 3. The grip portion 23 overlaps with the switch 5, or is located on the side opposite to the nozzle 3 with respect to the switch 5. This configuration can inhibit back spray. The grip portion 23 has an outer surface from the switch 5 to the tip of the portion 230. The outer surface bulges to the side opposite to the nozzle 3, and is gently curved. A palm of a user is thus placed along the curved surface, so that the user easily grips and handle the device 1. An axis 14 of the grip portion 23 may be tilted with respect to a straight line 11 orthogonal to an axis 13. In the example in FIG. 8, an angle θ1 formed by the axis 13 of the nozzle 3 and the axis 14 of the grip portion 23 is 79 degrees. In the embodiment, an angle θ2 is 29 degrees, and the ratio R of a distance 84 to a distance 83 is 0.30 to 0.31.

### Comparative Experiment

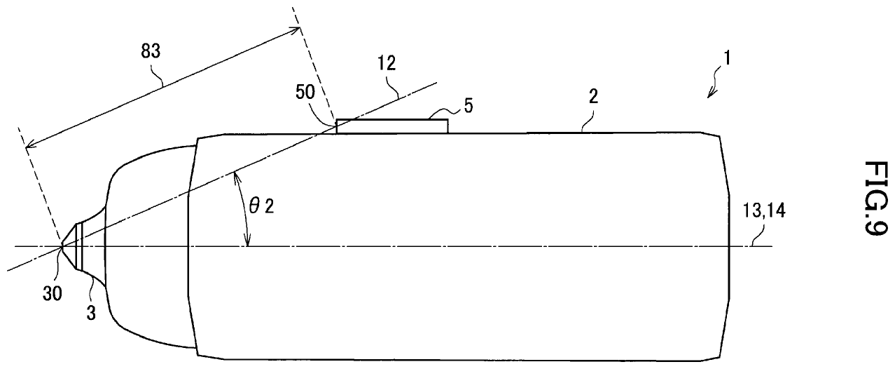

The present inventors conducted a comparative experiment on the devices 1 of the first to fourth embodiments and a device 1 of a comparative embodiment. The device 1 of the comparative embodiment in FIG. 9 has a columnar shape as a whole, and has a columnar housing 2, a nozzle 3, and a switch 5. The vicinity of the switch 5 in the housing 2 functions as a grip portion of the device 1. An axis 14 of the grip portion overlaps with an axis 13 of the nozzle 3. An angle θ1 formed by both axes 13 and 14 is 0 degrees. An angle θ2 formed by a virtual line 12 connecting a tip 30 of the nozzle 3 and an end 50 of the switch 5 on the side of the nozzle 3 and the axis 13 of the nozzle 3 is 20 degrees. A distance 83 between the tip 30 of the nozzle 3 and the end 50 of the switch 5 is 40 mm.

Electrostatic spinning was performed in the following conditions in the devices 1 of the first to fourth embodiments and the device 1 of the comparative embodiment. In each device 1, the switch 5 is made of stainless steel, and the housing 2 is formed of resin. Mixed liquid of (99.5%) 88 mass % of ethanol and 12 mass % of polyvinyl butyral was used as spinning liquid. Polyvinyl butyral manufactured by SEKISUI CHEMICAL CO., LTD.: Trade name S-LEC B BM-1 was used. The device 1 was gripped with a right hand, and spinning liquid was sprayed to a range of approximately 40 mm in diameter in the vicinity of the wrist of a left hand.

Straight-line distance from the tip 30 of a nozzle to skin: 120 mm

Applied voltage: 10.4 kV

Environmental temperature: 23° C.

Environmental relative humidity: 40% RH

Spray rate: 6 mL/h

Spray time: 20 seconds

As a result, in the device 1 of the comparative embodiment, back spray phenomenon was observed. In back spray phenomenon, for example, spinning liquid sprayed from a spray port of the nozzle 3 changes directions, turns around, and turns back to the side of a finger of a gripping right hand. In contrast, back spray toward the gripping right hand was not observed in the devices 1 of the first to fourth embodiments.

Although the preferred embodiments of the invention have been described in detail with reference to the accompanying drawings, the technical scope of the invention is not limited to such examples. It is clear that a person having ordinary knowledge in the technical field of the invention can come up with various changes or modifications within the scope of the technical ideas set forth in the claims. These changes or modifications are understood to naturally belong to the technical scope of the invention.

Regarding the above-described embodiments, the present invention also includes the following electrostatic spinning devices.

<1>

An electrostatic spinning device of handheld type having a shape or a size that allows a user to hold the electrostatic spinning device with a hand, comprising: a nozzle that sprays spinning liquid that has been charged; a switch that controls spray operation of the spinning liquid; and a housing that includes a bulging portion and a grip portion for grip of the user, the bulging portion bulging outward from a virtual line connecting a tip of the nozzle and an end of the switch on a side of the nozzle, an angle formed by an axis of the nozzle and an axis of the grip portion being 45 degrees or more.

<2>

The electrostatic spinning device according to <1>, in which the angle formed by the axis of the nozzle and the axis of the grip portion is preferably 60 degrees or more, preferably 90 degrees or less, and preferably 60 degrees or more and 90 degrees or less.

<3>

The electrostatic spinning device according to <1> or <2>, in which an angle formed by the axis of the nozzle and the virtual line is 25 degrees or more.

<4>

The electrostatic spinning device according to <3>, in which the angle formed by the axis of the nozzle and the virtual line is preferably 90 degrees or less, more preferably 45 degrees or less, preferably 25 degrees or more and 90 degrees or less, and more preferably 25 degrees or more and 45 degrees or less.

<5>

The electrostatic spinning device according to any one of <1> to <4>, in which a portion of the housing between the nozzle and the switch is a flattened portion, and the switch is disposed at a position corresponding to an outer edge portion of the flattened portion of the housing.

<6>

The electrostatic spinning device according to any one of <1> to <5>, in which a ratio of a distance between the virtual line and a vertex of the bulging portion to a distance between the tip of the nozzle and the end of the switch on a side of the nozzle is 0.20 or more.

<7>

The electrostatic spinning device according to <6>, in which the ratio is preferably 0.50 or less, more preferably 0.40 or less, preferably 0.20 or more and 0.50 or less, and more preferably 0.25 or more and 0.40 or less.

<8>

The electrostatic spinning device according to any one of <1> to <7>, in which a corner where a surface, from which the nozzle protrudes, and a surface, on which the switch is provided, intersect with each other corresponds to the vertex of the bulging portion.

<9>

The electrostatic spinning device according to any one of <1> to <8>, in which the switch overlaps with a center of the electrostatic spinning device, or is located on a side opposite to the nozzle with respect to the center in a direction along the axis of the nozzle.

<10>

The electrostatic spinning device according to any one of <1> to <9>, in which the grip portion overlaps with the switch, or is located on a side opposite to the nozzle with respect to the switch in a direction along the axis of the nozzle.

<11>

The electrostatic spinning device according to any one of <1> to <10>, in which the grip portion is positioned at an end opposite to the nozzle in the electrostatic spinning device.

<12>

The electrostatic spinning device according to any one of <1> to <11>, in which the grip portion is flattened, and

the switch is disposed on an outer edge portion of the grip portion.

<13>

The electrostatic spinning device according to any one of <1> to <12>, in which the switch sprays the spinning liquid from the nozzle by being pushed.

<14>

The electrostatic spinning device according to any one of <1> to <13>, in which the switch sprays the spinning liquid from the nozzle while being pushed, and stops spray when being detached.

<15>

The electrostatic spinning device according to any one of <1> to <14>, in which the switch is pushed in a direction toward an inside of the housing.

<16>

The electrostatic spinning device according to any one of <1> to <15>, in which one switch is provided.

<17>

The electrostatic spinning device according to any one of <1> to <16>, in which the grip portion has a portion extending away from the nozzle along an axis forming an angle larger than zero with respect to the axis of the nozzle.

<18>

The electrostatic spinning device according to any one of <1> to <17>, in which insulating material is used as material constituting the housing.

<19>

The electrostatic spinning device according to any one of <1> to <18>, having a region formed of conductive material at a position which a hand of a user comes into contact with during grip of the user.

<20>

The electrostatic spinning device according to any one of <1> to <19>, in which the switch is formed of conductive material.

<21>

The electrostatic spinning device according to any one of <1> to <20>, further comprising a cartridge that houses the spinning liquid and that is detachably mounted in a mounted portion of the housing.

<22>

The electrostatic spinning device according to any one of <1> to <21>, in which a length of a fiber in fibrous deposit (film) formed from the spinning liquid is at least 100 times or more a thickness of the fiber, preferably 10 μm or more, more preferably 50 μm or more, and even more preferably 100 μm.

<23>

The electrostatic spinning device according to any one of <1> to <22>, in which the spinning liquid contains following components (a), (b), and (c), and a mass ratio (b/c) of the component (b) and the component (c) is 0.4 or more and 50 or less:

(a) one or more types of volatiles selected from alcohol and ketone;

(b) water-insoluble polymer for fiber formation; and

(c) water.

### REFERENCE SIGNS LIST

1 Electrostatic spinning device
2 Housing
21 Bulging portion
23 Grip portion
3 Nozzle
5 Switch
12 Virtual line
13 Axis of nozzle
14 Axis of grip portion

1. An electrostatic spinning device of handheld type having a shape or a size that allows a user to hold the electrostatic spinning device with a hand, comprising:
a nozzle that sprays spinning liquid that has been charged;
a switch that controls spray operation of the spinning liquid; and
a housing that includes a bulging portion and a grip portion for grip of the user,
the bulging portion bulging outward from a virtual line connecting a tip of the nozzle and an end of the switch on a side of the nozzle,
an angle formed by an axis of the nozzle and an axis of the grip portion being 45 degrees or more.

2. The electrostatic spinning device according to claim 1, wherein the angle formed by the axis of the nozzle and the axis of the grip portion is 60 degrees or more and 90 degrees or less.

3. The electrostatic spinning device according to claim 1, wherein an angle formed by the axis of the nozzle and the virtual line is 25 degrees or more.

4. The electrostatic spinning device according to claim 3, wherein the angle formed by the axis of the nozzle and the virtual line is 25 degrees or more and 90 degrees or less.

5. The electrostatic spinning device according to claim 1,
wherein a portion of the housing between the nozzle and the switch is a flattened portion, and
the switch is disposed at a position corresponding to an outer edge portion of the flattened portion of the housing.

6. The electrostatic spinning device according to claim 1, wherein a ratio of a distance between the virtual line and a vertex of the bulging portion to a distance between the tip of the nozzle and the end of the switch on a side of the nozzle is 0.20 or more.

7. The electrostatic spinning device according to claim 6, wherein the ratio is 0.20 or more and 0.50 or less.

8. The electrostatic spinning device according to claim 1, wherein a corner where a surface, from which the nozzle protrudes, and a surface, on which the switch is provided, intersect with each other corresponds to the vertex of the bulging portion.

9. The electrostatic spinning device according to claim 1, wherein the switch overlaps with a center of the electrostatic spinning device, or is located on a side opposite to the nozzle with respect to the center in a direction along the axis of the nozzle.

10. The electrostatic spinning device according to claim 1, wherein the grip portion overlaps with the switch, or is located on a side opposite to the nozzle with respect to the switch in a direction along the axis of the nozzle.

11. The electrostatic spinning device according to claim 1, wherein the grip portion is positioned at an end opposite to the nozzle in the electrostatic spinning device.

12. The electrostatic spinning device according to claim 1,
wherein the grip portion is flattened, and
the switch is disposed on an outer edge portion of the grip portion.

13. The electrostatic spinning device according to claim 1, wherein the switch sprays the spinning liquid from the nozzle by being pushed.

14. The electrostatic spinning device according to claim 1, wherein the switch sprays the spinning liquid from the nozzle while being pushed, and stops spray when being detached.

15. The electrostatic spinning device according to claim 1, wherein the switch is pushed in a direction toward an inside of the housing.

16. The electrostatic spinning device according to claim 1, wherein one switch is provided.

17. The electrostatic spinning device according to claim 1, wherein the grip portion has a portion extending away from the nozzle along an axis forming an angle larger than zero with respect to the axis of the nozzle.

18. The electrostatic spinning device according to claim 1, wherein insulating material is used as material constituting the housing.

19. The electrostatic spinning device according to claim 1, having a region formed of conductive material at a position which a hand of a user comes into contact with during grip of the user.

20. The electrostatic spinning device according to claim 1, wherein the switch is formed of conductive material.

21. The electrostatic spinning device according to claim 1, further comprising a cartridge that houses the spinning liquid and that is detachably mounted in a mounted portion of the housing.

22. The electrostatic spinning device according to claim 1, wherein the spinning liquid allows formation of deposit of fibers on a surface of an object, and a length of each of the fibers in the deposit is at least 100 times or more a thickness of the fiber.

23. The electrostatic spinning device according to any claim 1, wherein the spinning liquid contains following components (a), (b), and (c), and a mass ratio (b/c) of the component (b) and the component (c) is 0.4 or more and 50 or less:
(a) one or more types of volatiles selected from alcohol and ketone;
(b) water-insoluble polymer for fiber formation; and
(c) water.
